(19) United States
(12) Patent Application Publication
(10) Pub. No.: US 2006/0114521 A1
(43) Pub. Date: Jun. 1, 2006

(54) Method and apparatus for improving color registration in contact-image-sensor scanners

(76) Inventors: James R. Bailey, Shelbyville, KY (US); James L. Bush III, Lexington, KY (US); Joseph K. Yackzan, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 11/001,965

(22) Filed: Dec. 1, 2004

(51) Int. Cl. H04N 1/04

(52) U.S. Cl. 358/474

(57) ABSTRACT

A method, and a document scanning apparatus employing the method, of scanning with a light source. The method comprises the acts of determining a calibration time of the light source and light sensor in a scanning unit, adjusting an activation time for the light source based on the calibration time, scaling a clock signal based on the activation time, and activating the light source based on the scaled clock signals. Where a red, green and blue LED light source is used, the longest of the activation times of the LEDs is used for the scaling of the clock signals. In another embodiment, the time between the start of the activation of last LED scan on a previous scan line and the start of activation of the first LED on the subsequent scan line is adjusted to maintain the predetermined resolution used for the scan.

### CROSS REFERENCES TO RELATED APPLICATIONS

None.

### STATEMENT REGARDING FEDERALLY SPONSORED RESEARCH OR DEVELOPMENT

None.

### REFERENCE TO SEQUENTIAL LISTING, ETC.

None.

### BACKGROUND

Embodiments of the invention relate to image scanning, and more particularly to color registration during image scanning.

To scan an image, a multi-pass scanner uses a scanner carriage motor to move a scanning device over an image such that different colors can be exposed at different passes. The movements of the scanning device using the scanner carriage motor can cause non-uniformity and inconsistency in the alignment of the colors in the scanned image. Misalignments in the red, green, and blue channels of the scanned image are referred to as color registration errors.

Some single-pass scanners, such as contact image sensor (“CIS”) scanners, use only one row of sensing elements to scan the image such that different colors are exposed consecutively. However, using one row of sensing elements with three separate light sources to scan images also causes color registration errors. For example, in capturing a scan line height of 1/600″ using a single-pass CIS scanner with image sensor height of 1/600″, a first light emitting diode (“LED”) light source of a first color (such as red) is turned on at time t₀. The first color of the scan line is captured. At time t₁, a second LED light source of a second color (such as green) is turned on, and the second color of the scan line is captured. However, the sensor elements have already moved from a first area of the scan line to a second area of the scan line between time t₀ and time t₁ at some velocity. That is, the first area of the scan line that was exposed using the first LED is slightly different than the second area of the scan line that was exposed using the second LED. In fact at time t₁, only ⅔ of the first scan line and only ⅓ of a second scan line are captured by the second LED. At time t₂, a third LED light source of a third color (such as blue) is turned on, and the third color for the first scan line is to be captured. However, only ⅓ of the first scan line and ⅔ of the second scan line are captured by the third LED, respectively. As a result, three different areas are scanned for each scan line. If the scan line is on the white side of a white to black edge transition, the captured red line can have no color, the green line can have ⅔ light and ⅓ dark, and the blue line can have ⅓ light and ⅔ dark. The captured image can then have a color fringe.

The single-pass scanners are prone to have y-direction color registration error. Common techniques for improving color registration include scanning the image at a higher resolution in the y-direction, and downscaling the scanned image. For example, if the user selects a 600 pixel per inch (“ppi”) scan mode, the image is subsequently scanned at 1200 ppi and downscaled to 600 ppi to improve the color registration by roughly a factor of two. One deficiency of the downscaling high resolution scanning technique is the amount of memory required to store a 1200 ppi image as well as the amount of memory bandwidth consumed by a 1200 ppi scan. For standalone devices such as printer-scanner-copiers, the amount of time to complete a copy operation is dictated by the amount of consumed memory bandwidth inside the controller or application-specific integrated circuit (“ASIC”). Another deficiency of the downscaling high resolution scanning technique is the increased time for capturing a scanned line in a higher resolution mode. Scanning at a higher resolution can also increase the amount of time needed to complete a standalone copy operation, which may be detrimental to the scanner specifications.

Effects of color registration error include an appearance of a color fringe around edges of text and sharp lines in a scanned image. Color registration error often appears as blurry text in a scanned image. Additionally, color registration error often results in a lower modulated transfer function (“MTF”) measurement for a scanner as edges are blurred by the misaligned colors. Color registration error also has a negative effect on image processing techniques that attempt to identify regions of the scanned image that are black text. These image-processing techniques take advantage of region identification to optimize the output of a device. For example, in multi-functional devices such as scanner-printer-copiers, a detection of black text in a scanned image can result in print optimizations such as speed and quality improvements for such regions during a copy operation. Color registration error can prohibit such image processing techniques from detecting and optimizing these regions.

### SUMMARY

The distance that the sensor elements have moved between time t₀ and time t₁ can be represented by Δ1. Similarly, the distance that the sensor elements have moved between time t₁ and time t₂ can be represented by Δ2, and the distance that the sensor elements moved between time t₀ and time t₂ can be represented by Δ3. The variables Δ1, Δ2, and Δ3 generally represent color registration errors. That is, minimizing these variables Δ1, Δ2, and Δ3 will reduce the color registration error.

Accordingly, there is a need for improved registration scanning, or minimizing color registration without affecting the overall scan time or available memory resources. There is also a need to provide consistent color registration results throughout the life of the scanner despite degradation of the intensity of the LED. In one form, the invention provides a method of scanning with a light source and a light sensor. The method includes the acts of determining a calibration time of the combination of the light source and light sensor, and adjusting an activation time for the light source based on the calibration time. The method also includes the acts of scaling a clock signal based on the activation time and the amount of scan data to be moved from the light sensor, and activating the light source based on the scaled clock signals.

In another form, the invention provides a method for scanning with a light source. The method includes the acts of calibrating a plurality of activation times of the light source, and determining a plurality of start pulses based on one of the activation times. The method also includes the act of reducing a time for activating the light source between the start of the activation of the last light source of the previous scan line and the start of activation of the first light source of the subsequent scan line in order to maintain the predetermined scanning resolution.

In yet another form, the invention provides a scanner. The scanner includes a scanner clock having a control frequency. The scanner also includes a movable scanning unit for scanning at a predefined scanning resolution comprised of plurality of light sources and a light sensor for collecting data. Each of the plurality of light sources has an activation time, and is activated by a start pulse for the activating time. A processor calibrates the activation times of the plurality of light sources in combination with the light sensor, selects one of the activation times based upon a predefined criteria, and sets the control frequency of the scanner clock based on the selected activation time and the amount of scan data to be moved from said light sensor for further processing by said processor. The light sources can include red, green and blue LEDs.

Other features and advantages of the invention will become apparent to those skilled in the art upon review of the following detailed description, claims, and drawings.

### BRIEF DESCRIPTION OF THE DRAWINGS

The patent or application file contains at least one drawing executed in color. Copies of the patent or patent application publication with color drawings(s) will be provided by the Office upon request and payment of the necessary fee.

In the drawings:

FIG. 1 shows a scanner system;

FIG. 2 shows a plurality of moving light-emitting-diode positions with respect to a scan line;

FIG. 3 shows a timing diagram of a plurality of scanner system signals;

FIG. 4 shows a flow chart illustrating an exemplary color registration error minimization process;

FIG. 5 shows a magnified scan of two solid black lines before the exemplary color registration error minimization process is applied showing a red color misregistration along the top edge and a blue color misregistration along the bottom end; and

FIG. 6 shows a magnified scan of two solid black lines after the exemplary color registration error minimization process has been applied showing the reduction in the red and blue color misregistrations.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. In addition, the terms “connected” and “coupled” and variations thereof are not restricted to physical or mechanical connections or couplings.

### DETAILED DESCRIPTION

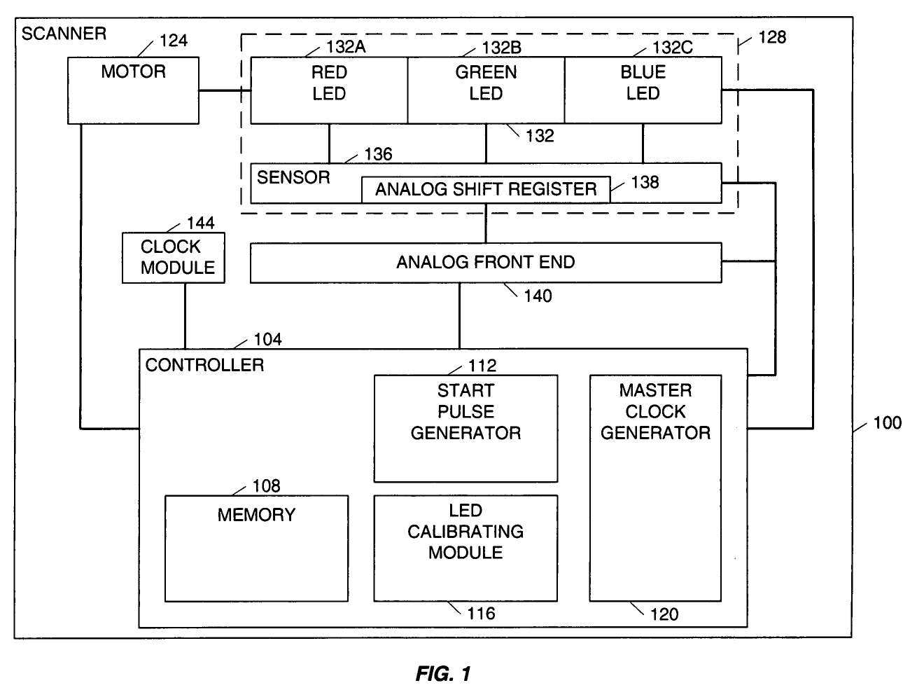

FIG. 1 shows a scanner system 100 in a block diagram format. The system 100 includes, without limitation, a controller 104 that controls the operations of the scanner system 100. The controller 104 can be a general-purpose micro-controller, a general-purpose microprocessor, a dedicated microprocessor or controller, a signal processor, an application-specific-integrated circuit (“ASIC”), or the like. In some embodiments, the controller 104 and its functions described are implemented in a combination of firmware, software, hardware, and the like. In the embodiments shown, the controller 104 includes a memory 108 that stores a variety of information including light-emitting-diode (“LED”) data and clock frequency data. The controller 104 also includes a start pulse generator 112 that generates a start pulse at which time data is to be shifted out of a plurality of image sensors. The controller 104 uses an LED-calibrating module 116 to calibrate the LED's activation time, and a master clock generator 120 that generates and determines a master clock or a control signal that has a corresponding master clock frequency. Although the memory 108, the start pulse generator 112, the LED-calibrating module 116, and the master clock generator 120 are shown being internal to the controller 104, some of them can also be individual circuits that are external to the controller 104. In such cases, the memory 108, the start pulse generator 112, the LED-calibrating module 116, and the master clock generator 120 can be configured to communicate with the controller 104 via information buses.

The LED-calibrating module 116 initially determines a time that a plurality of LED's 132 are to be activated or turned on for the scanning system 100 in an LED-calibration process. In some embodiments, the plurality of LED's 132 include a red LED 132A, a green LED 132B, and a blue LED 132C. Furthermore, in some embodiments, it is common for one color LED to have different LED characteristics than another color LED in the scanner system 100. For example, the intensity level can vary from one color LED to another color LED due to manufacturing variations, and aging. For another example, different scan modes offered by the scanner system 100 can also have unique target voltages requiring the LED-calibration process to take place for each of the scan modes. Consequently, the LED-calibration process can be used to adjust the unique characteristics of each of the LED's 132. For example, the LED-calibrating module 116 can be configured to calibrate each of the LED's 132 every time the scanner system 100 is used to scan an image. Details of an exemplary calibration method are disclosed below. In this way, the LED-calibrating module 116 can set an activation time or an on-time for each of the LED's 132 such that a voltage swing of an associated sensor is at least comparable to or about identical between scanned colors. A maximum value of the voltage swing is generally used in some embodiments to maximize a signal-to-noise ratio of the scan line data. In some other embodiments, however, an increased value of the voltage swing can be used to increase a signal-to-noise ratio of the scan line data.

The scanner system 100 also includes a motor 124 that moves a scanning unit 128 along a scan window at a predetermined velocity. The scanning unit 128 further includes a sensor 136 that senses the scan line and generates data based on the scan line. The sensor 136 also includes an analog shift register 138 that shifts the scanned analog data serially out of the sensor 136 based on the master clock or the control signal generated by the master clock generator 120, detailed hereinafter. The scanner system 100 also includes an analog front end (“AFE”) device 140 that receives the scan line data in an analog format from the shift register 138. The AFE device 140 then converts the scan line data from the analog format to a digital format, and sends the converted scan line data out to the controller 104. Like the activation time, or the on-time of each of the LED's 132, the frequency of a master clock, which is based on frequency generated by a clock module 144, can also vary. Thus, the controller 104 can determine a starting time for each of the LED's 132 to expose each color line for a predetermined amount of activation time.

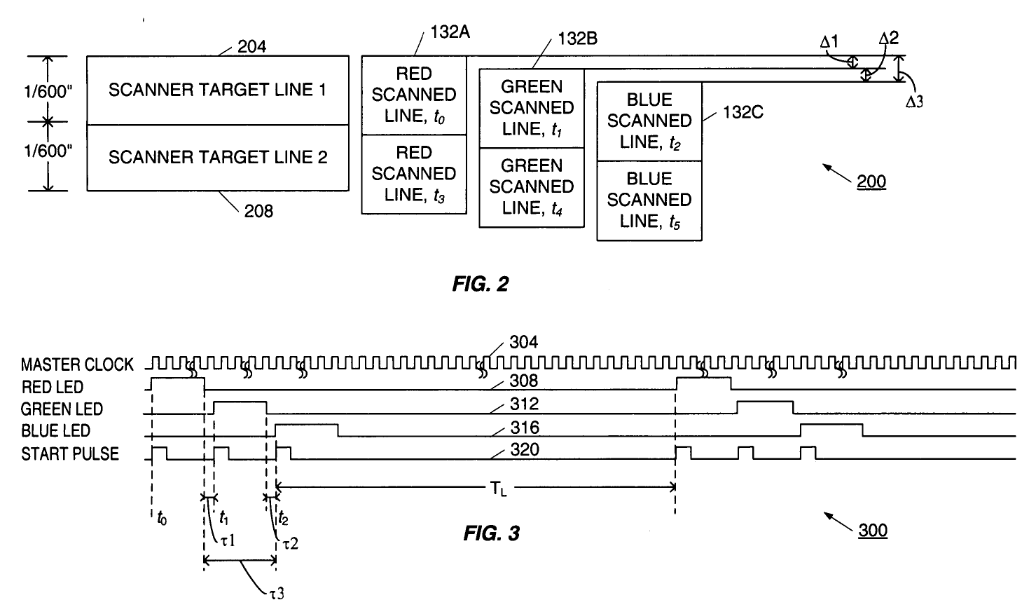

FIG. 2 shows a plurality of positions of the LED's 132 exposing a scanner target line or scan line 204 at times, t₀, t₁, and t₂, respectively. FIG. 2 also shows that the distances that the LED's 132 have moved between time t₀ and time t₁, between time t₁ and time t₂, and between time t₀ and time t₂ and are represented by Δ1, Δ2, and Δ3, respectively. The values of Δ1, Δ2, and Δ3 are often used to determine an amount of color registration error of the scanned image. The illustrated scan line 204 also has a scanner line resolution of 1/600″. As shown in FIG. 2, since the motor 124 is moving, a different area of the scan line 204 is being exposed by the color LED's 132. Each scanner target line 204 or 208 can be thought of as three single color scan lines, one for the red LED, one for the green LED and one for the blue LED.

FIG. 3 shows a timing diagram 300 of a plurality of signals including a master clock 304 generated by the master clock generator 120, and a plurality of LED control signals. The LED control signals include a red LED control or activation signal 308, a green LED control or activation signal 312, and a blue LED control or activation signal 316. The red LED control signal 308 is indicative of an exposure or activation time of the red LED 132A. Similarly, the green LED control signal 312 and the blue control LED 316 indicate exposure or activation times of the green LED 132B and the blue LED 132C, respectively. The red LED control signal 308 has a first rising or a first transition at to shown in FIG. 2. The green LED control signal 312 has a second rising or a second transition at t₁ also shown in FIG. 2. The blue LED control signal 316 has a third rising or a third transition at t₂ also shown in FIG. 2. The timing diagram 300 also shows a start pulse signal 320 that is generated by the start pulse generator 112. The start pulse signal 320 also signals when the previously exposed line begins shifting out of the image sensor 136 to the AFE device 140. While the current line 204 is being exposed with a given color LED, the previous line is being shifted out of the image sensor 136 to the AFE device 140. The master clock 304 is used to clock out the data serially from the shift register 138 contained within the image sensor 136.

The times between the end of the first LED activation pulse and the second start pulse, between the end of second LED activation pulse and the third start pulse, and between the end of the first LED activation pulse and the third start pulse are referred to as τ1, τ2, and τ3, respectively. The values of τ1, τ2, and τ3 for a single scan line are minimized based on the LED calibration. In some embodiments, τ1, τ2, and τ3 are minimized or reduced by maximizing or increasing the frequency of the master clock 304 and all other scanner control signals without affecting the activation time of the LED's 132. By minimizing the values of τ1, τ2, and τ3, the values of Δ1, Δ2, and Δ3 are then also minimized. As a result, the corresponding color registration error can be minimized. The values of τ1 and τ2 can be equal to one another or be different from one another.

In some embodiments, T_{L} is defined as a time between the beginning of the last start pulse for the last to be activated LED of the current scanner target line 204 and a first start pulse for the first LED to be activated for a next scanner target line 208. As shown in FIG. 3, T_{L} represents the time between the capture and shifting of the data for the blue LED and the start of the activation of the red LED in next scan line 208. Furthermore, the value of T_{L} is set such that the data from the last activated LED (here the blue LED) of current scan line 204 is captured and shifted out to the analog front end 140 while next scanner target line 208 is still captured at the scanner line resolution ( 1/600″ as illustrated). As a result, the value of T_{L} can be different from any of the values of τ1, τ2, and τ3. In this way, very little or no dead time will exist between activating and exposing the last of the LEDs in current scanner target line 204 and completely shifting data of a previous line out of the sensor 136 and the start of the next scan line.

Referring to both FIG. 2 and FIG. 3, with τ1 minimized or reduced, this minimizes Δ1 minimizing the color registration error for the corresponding line 204. Furthermore, between scans of corresponding colors, for example between the red scan line of scanner target line 204 and the red line of target scanner line 208, the system ensures that the scanner unit 128 has moved the correct distance corresponding to the predetermined scanner resolution. For the illustrated system, this would be a distance of 1/600″. Other scanner resolutions such as 1/300inch, 1/600 inch, 1/1200 inch and 1/2400 inch, and 1/4800 inch can also be used. The value of T_{L} can be adjusted (increased or decreased) to ensure that the correct distance is traveled by the scanner unit 128 to ensure that the predetermined scanner resolution is maintained. While the ideal values of Δ1, Δ2, and Δ3 are about zero, the values of Δ1, Δ2, and Δ3 are minimized or reduced based on the result of the LED-calibration process. In FIG. 3, the values of τ1, τ2, and τ3 have been minimized or reduced to almost zero, and the master clock 304 has been maximized to clock out data from a previously exposed line faster based upon the longest required activation time. Specifically, while the current scan line 204 is being exposed, say the green LED scan line, data from the previously exposed and scanned red LED scan line is completely shifted out of the sensor 136 with almost no extra time required to complete the shifting process. As a result, if the characteristics (such as the intensity level) of the LED's 132 change over time, the system 100 can adjust the frequency of the master clock 304 accordingly. In this way, times for shifting of data can remain consistent, which minimizes or reduces color registration error.

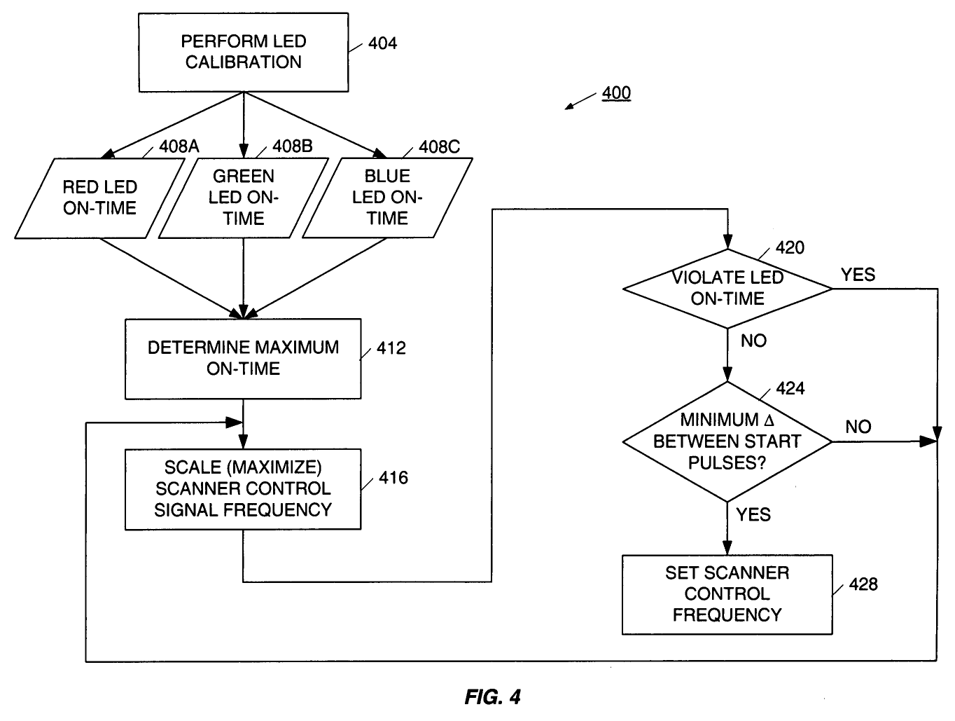

FIG. 4 includes a flow chart 400 that further illustrates processes that occur in some embodiments including processes that may be carried out by software, firmware, or hardware. As noted, the system 100 (of FIG. 1) will perform an LED calibration at block 404 due the differences of LED characteristics such as intensity levels. Specifically, an increased or a maximum target for the sensor 136 (of FIG. 1) is identified or determined. In some embodiments, the target voltage can range from about 0.5 V to about 1.5 V. Once identified or determined, the activation time or the on time necessary to charge up each of the image sensors 136 to the increased or maximum target voltage when exposed to a white target is determined. Thereafter, each of the corresponding individual colored LED's 132A, 132B and 132C can be calibrated to activate or turn on for the determined amount of activation time at blocks 408A, 408B, and 408C, respectively to achieve the desired signal to noise ratio. In some embodiments, the activation time or the on-time can range from 1 msec to 10 msec. Of course, other sensors can require other activation times. Thereafter, a maximum or an increased on time among all the activation time or on-times of the LEDs 132A. 132B and 132C is determined at block 412.

At block 416, the system 100 determines and adjusts the master clock frequency generated by the master clock generator 120 (of FIG. 1). Particularly, once the activation time for each of the LED's 132 has been determined, the controller 104 (of FIG. 1) determines from the memory 108, from a sequence table (not shown), or from a predetermined formula, a new frequency for the master clock 304. More particularly, the controller 104 determines the new frequency for the master clock 304 based on the maximum activation time among of the LEDs in the scanning unit 128 and the frequency generated by the clock module 144. This new frequency is then used for each of the LEDs in the sensor 136. An optimal frequency of the master clock 304 can be obtained by dividing the amount of data needed to be shifted out by the maximum activation time or the increased activation time. In other words, the LED requiring the longest activation time for the sensor 136 to reach the desired response level serves as the limiting factor for determining the optimal master clock frequency to be used for the scan. For example, assume that the green LED requires the longest activation time, say 2.0 msec while the red and blue LEDs each have a 1 msec activation time, and a 9 inch, 600 pixels per inch scan bar is being used. Each scan line has 5400 pixels of data to be shifted out. For the example, an optimal master clock frequency of 2.7 MHz is obtained and this frequency would also be used for the red LED and blue LED scan lines and is set prior to the start of the scan. If either the red or blue LED activation times were used to establish the master clock frequency, then the green LED will not be on long enough for the sensor to achieve the desire voltage output, thus reducing the signal to noise ratio. In some embodiments, the master clock frequency ranges from 1 MHz to more than 6 MHz. Of course, other sensors can have other saturation levels, and therefore a different master clock frequency can be used.

Depending on the clock frequency supplied to the controller 104 by the clock module 144, the optimal master clock frequency generated at block 416 may not match exactly with the frequencies that can be generated by the master clock generator 120 or the sequence table. In such cases, an increased master clock frequency is used in place of the optimal master clock frequency. For example, the master clock generator 120 may be configured to generate a master clock frequency between 1.0 MHz to 6.0 MHz with a frequency increment of 0.5 MHz. In such a case, an optimal master clock frequency of 2.7 MHz falls between 2.5 MHz and 3.0 MHz. To use one of these new master clock frequencies, the system 100 initially selects one of these frequencies also at block 416. Thereafter, the system 100 starts a validation process that checks to determine if the selected master clock frequency satisfies some predetermined conditions. For example, the system 100 checks to determine if the selected master clock frequency at block 416 can allow enough time for exposing the LED's 132 and for shifting out the scan line data at block 420. Furthermore, in some embodiments, the system 100 also checks at block 420 to determine if the activation time determined will result in saturation of the sensor 136. If the system 100 determines that the activation time of the LED's 132 has been violated, a second master clock frequency is selected at block 416. The system 100 then repeats the validation process. In some embodiments, however, the system 100 can use the validation process to check the selected master clock frequency as described, even when the master clock generator 120 can generate the determined maximum frequency.

If the selected master clock frequency at block 416 allows enough time for exposing the LED's 132, for shifting out the scan line data (block 420) without saturating the sensor 136 the validation process continues. Since the selected master clock frequency also changes the time between the end of an activation pulse the and next start pulse (τ1, τ2, and τ3), the system 100 also checks to determine if the new values of τ1, τ2, and τ3 can result in minimum or reduced values of Δ1, Δ2, and Δ3 at block 424. If the selected master clock frequency does not result in minimum or reduced values of Δ1, Δ2, and Δ3, the system 100 then selects a second master clock frequency at block 416, and repeats the validation process. However, if the selected master clock frequency can result in minimum or reduced values of Δ1, Δ2, and Δ3, the system 100 then sets the frequency of the scanner master clock 304 to the selected master clock frequency at block 428.

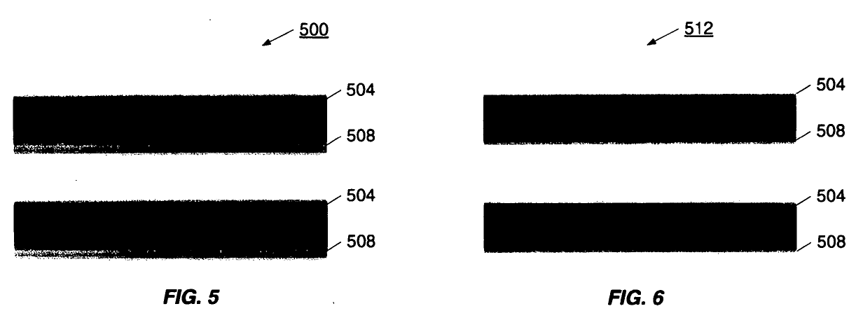

FIG. 5 shows a scan 500 of two solid black lines taken at 300 ppi zoomed in 500 percent before applying the process discussed in FIG. 4. Since the red, green, and blue channels are misaligned in the y-direction, there is a red fringe at a top edge 504 of the lines, and a blue fringe at a bottom edge 508. Particularly, the scan 500 has a color registration error value of about 0.46 pixel. FIG. 6 shows a second scan 512 of the same solid black lines (from which the scanned image of FIG. 5 is obtained) at 300 ppi zoomed in 500 percent after applying the process discussed in FIG. 4. The color fringes 504, 508 near the top and bottom edges, respectively, which are indicative of color registration error, are reduced. Furthermore, the second scan 512 has a color registration error value of about 0.20 pixel or an improvement of fifty percent over that shown in FIG. 5.

Various features and advantages of the invention are set forth in the following claims.

1. In a document scanning apparatus having a scanning unit comprising light source and a light sensor for collecting scan data at a predetermined scanning resolution, a method of scanning with a light source comprising the acts of:
determining a calibration time of the combination of the light source and light sensor;
adjusting an activation time for the light source based on the calibration time;
scaling a clock signal based on the activation time; and
activating the light source based on the scaled clock signal.

2. The method of claim 1, wherein determining the calibration time further comprises activating the light source and measuring the activation time until the light sensor reaches a predetermined output value in response to the light source.

3. The method of claim 2, wherein the light source comprises a first light-emitting-diode (“LED”) and at least a second LED, further comprising:
the determining act determining the calibration time for the combination of the first LED and light sensor and the calibration time of the combination of the at least second LED and light sensor;
the adjusting act adjusting the activation time of the first LED and the activation time of the second LEDs based upon their respective calibration times;
the scaling act scaling the clock signal based upon the longest of the activation times; and
sequentially activating the first and second LEDs based on the scaled clock signal for scanning a line at a predetermined resolution.

4. The method of claim 3 further comprising reducing a time between the end of the activation time for the first LED and the start of the activation time of the second LED.

5. The method of claim 4 further comprising minimizing the time between the end of the activation time for the first LED and the start of the activation time of the second LED.

6. The method of claim 3 further comprising performing the acts of determining, adjusting, scaling and sequentially activating for a red LED, a green LED and a blue LED in said light source.

7. The method of claim 3 further comprising adjusting the time between the start of the activation of the last LED in the scanning of a previous scan line and the start of the activation of the first LED in the scanning of a subsequent scan line such that the predetermined scanning resolution is maintained between the start of activation of the first LED of the previous scan line and the start of activation of the first LED on the subsequent scan line.

8. The method of claim 7 wherein the predetermined scanning resolution is selected from a group consisting of 1/300 inch, 1/600 inch, 1/1200 inch and 1/2400 inch, and 1/4800 inch.

9. The method of claim 7, further comprising completely shifting data of the previous scan line out of the sensor during the activation time of the subsequent scan line.

10. The method of claim 1 wherein the act of scaling the clock signal further comprises:
determining the amount of scan data to be moved out of the scanning unit; and
determining a clock frequency based on said amount of data and the activation time.

11. The method of claim 10 further comprising:
reperforming the acts of determining a calibration time, adjusting an activation time based on said scaled clock frequency; and
determining if said scanning unit operates within predetermined operating parameters at said scaled clock signal.

12. The method of claim 11 wherein the predetermined operating parameters are selected from a group consisting of signal to noise ratio, light sensor saturation time, light sensor output level, and scanning resolution, and combinations of one or more of the foregoing.

13. The method of claim 12, further comprising completely shifting data of the previous scan line out of the sensor during the activation time of the subsequent scan line and the predetermined operating parameters further include data shifting times.

14. A method for scanning media with a scanning unit comprising a light source having a plurality of light emitting diodes (“LEDs”) and a light sensor for collecting scan data at a predetermined scanning resolution, the method comprising:
calibrating the plurality of LEDs of the light source in combination with the light sensor;
determining for each LED an activation time based on its respective calibration;
determining a clock frequency for a plurality of start pulses for correspondingly activating the plurality of LEDs of the light source based on a selected one of the activation times;
scanning a line of the media by activating the plurality of LEDs to illuminate the media using corresponding start pulses based upon the selected one of the activation times;
collecting scan data from the scan line in the light sensor based on the light reflected from the scanned media by each LED during selected one of the activation times; and
adjusting a time for activating the light source for the next scan line to maintain said predetermined scanning resolution.

15. The method of claim 14, wherein determining the calibration time further comprises activating the each of the plurality of LEDs and measuring the activation times until the light sensor reaches a predetermined output value in response to the light source.

16. The method of claim 14 further comprising selecting the longest activation time as the selected one of the activation times.

17. The method of claim 14 wherein the plurality of LEDs are sequentially activated during scanning of the scan line and the plurality of LEDS comprise at least one red LED, one green LED and one blue LED.

18. The method of claim 17 further comprising adjusting the time between the start of the activation of the last LED in the scanning of a previous scan line and the start of the activation of the first LED in the scanning of a subsequent scan line such that the predetermined scanning resolution is maintained between the start of activation of the first LED of the previous scan line and the start of activation of the first LED on the subsequent scan line.

19. The method of claim 18 wherein the predetermined resolution is selected from a group consisting of 1/300 inch, 1/600 inch, 1/1200 inch and 1/2400 inch, and 1/4800 inch.

20. The method of claim 16 wherein the act of determining the clock frequency for the plurality of start pulses further comprises:
determining the amount of scan data to be moved out of the scanning unit;
determining a clock frequency based on said amount of data and said selected one of the activation times; and
using said clock frequency to generate said plurality of start pulses and adjust the remaining plurality of activation times to correspond to said selected one of the activation times.

21. The method of claim 20 further comprising:
reperforming the act of calibrating based on said selected clock frequency; and
determining if said scanning unit operates within predetermined operating parameters at said selected clock signal.

22. The method of claim 21 wherein the predetermined operating parameters are selected from a group consisting of signal to noise ratio, light sensor saturation time, light sensor output level, and scan resolution, and combinations of one or more of the foregoing.

23. The method of claim 12, further comprising for completely shifting scan data of the previously activated LED out of the light sensor during the activation time of the subsequently activated LED and the predetermined operating parameters further include data shifting times.

24. A scanner comprising:
a scanner clock having a control frequency used to create a plurality of start pulses;
a movable scanning unit for scanning at a predefined scanning resolution comprising:
a light sensor for collecting scan data;
a plurality of light sources, each of the plurality of light sources having an activation time configured to be activated by one of the plurality of start pulses; and
a processor adapted to calibrate the activation times of the plurality of light sources in combination with the light sensor, to select one of the activation times based upon predefined criteria, to set the control frequency of the scanner clock based on the selected activation time and the amount of scan data to be moved from said light sensor for further processing by said processor.

25. The scanner of claim 24, wherein the processor is further adapted to adjust a time for activating the light source for the next scan line to maintain said predetermined scanning resolution.

26. The scanner of claim 24, wherein the processor is further adapted to adjust the time between the start of the activation of the last light source in the scanning of a previous scan line and the start of the activation of the first light source in the scanning of a subsequent scan line such that the predetermined scanning resolution is maintained between the start of activation of the first light source of the previous scan line and the start of activation of the first light source on the subsequent scan line.

27. The scanner of claim 24 where in the plurality of light sources comprise at least one red LED, one green LED and one blue LED and the processor is further adapted to sequentially activate said LEDs.

28. The scanner of claim 24 wherein the predefined criteria is the longest activation time.

29. The scanner of claim 24 wherein the processor is further adapted to calibrate by determining the calibration time by activating the each of the plurality of light sources and measuring the activation times until the light sensor reaches a predetermined output value in response to the light source.

30. The scanner of claim 29 wherein the predetermined operating parameters are selected from a group consisting of signal to noise ratio, light sensor saturation time, light sensor output level, and scan resolution, and combinations of one or more of the foregoing.

31. The scanner of claim 24 wherein the predetermined scanning resolution is selected from a group consisting of 1/300 inch, 1/600 inch, 1/1200 inch and 1/2400 inch, and 1/4800 inch.

32. The scanner of claim 24, wherein the processor is further adapted to completely shift data of the previous scan line out of the light sensor during the activation time of the subsequent scan line.
